(19) United States
(12) Patent Application Publication
(10) Pub. No.: US 2007/0064701 A1
(43) Pub. Date: Mar. 22, 2007

(54) WLAN data reception method and device

(75) Inventors: Jeff Lin, Taipei (TW); Jiun-Jang Su, Taipei (TW); You-Hu Yen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/229,938

(22) Filed: Sep. 19, 2005

(51) Int. Cl. H04L 12/28

(52) U.S. Cl. 370/392; 370/401

(57) ABSTRACT

A method and device receiving a WLAN signal in a receiver. The receiver comprises a receiving module and a controller module. The receiving module receives first data. The controller module coupled to the receiving module determines second data from the first data, and disables the receiving module if the second data does not correspond to identity information of the receiver.

### BACKGROUND

The invention relates in general to wireless data reception, and in particularly, to a Wireless Local Area Network (WLAN) data reception method and device.

Power efficiency remains an important issue for wireless device, which typically employ portable power storage cells such as batteries, storage capacity of which is inherently limited, requiring effective power management solution.

An IEEE 802.11 based WLAN operates under either an infrastructure mode or an ad-hoc mode. In infrastructure mode, the WLAN comprises wireless clients and a wireless access point (AP), whereby wireless clients can communicate with each other or an intranet; whereas in ad-hoc mode, the WLAN constitutes wireless clients only, communicating with each other without wireless AP.

WLAN deploys Carrier Sense Multiple Access with Collision Avoidance (CSMA/CA) scheme as the data access method. In CSMA/CA scheme the transmission media is shared by every station including every wireless client and AP in the network. Any station wishing to transmit must detect the condition of the radio channel in advance. The station may transmit data if the radio channel is free. If the channel is already occupied by a data transmission, the station has to wait until the channel is released again. The duration of channel occupation is referred as “Busy Medium” period. Upon completion of each Busy Medium period, the regulation requires each station to postpone for a finite period of time, known as an Interframe Space (IFS) period, prior to enquiring for the next transmission session.

As WLAN data is broadcasted in the WLAN network, each wireless client can identify the validity of the data through the recipient address in the WLAN data frame. Conventionally, each wireless client in the WLAN network receives a complete WLAN data frame, and retains or discards the WLAN data depending on the recipient address. If the recipient address does not correspond to the wireless client, unnecessary power is expended retrieving the WLAN data frame.

Thus a method and device for WLAN data reception is presented in the present invention to control power utilization of a WLAN receiver.

### SUMMARY

A method of receiving data comprises receipt of first data in a receiving module of a receiver, determining second data from the first data, and disabling the receiving module if the second data does not correspond to identity information in the receiver.

A device for receiving data comprises a receiving module and a controller module. The receiving module receives first data. The controller module, coupled to the receiving module, determines second data from the first data, and disables the receiving module if the second data does not correspond to an identity information of the receiver.

Another method of receiving data comprises receipt of first data in a receiving module of a receiver, determining recipient address from the first data, disabling the receiving module if the recipient address does not correspond to a receiver address of the receiver, and enabling the receiving module upon expiration of an Interframe Space associated period.

### BRIEF DESCRIPTION OF THE DRAWINGS

The invention will become more fully understood from the detailed description, given hereinbelow, and the accompanying drawings. The drawings and description are provided for purposes of illustration only and, thus, are not intended to be limiting of the present invention.

FIG. 1 shows a WLAN data frame in Media Access Control (MAC) layer in IEEE 802.11 specification.

FIG. 2 is a block diagram of a receiver, according to one embodiment of the present invention.

FIG. 3 is a schematic diagram of IFS timing relationship in WLAN specification based on CSMA/CA.

FIGS. 4 (a) and (b) are timing diagrams of WLAN signals with correct recipient address and with incorrect recipient address incorporating the WLAN receiver in FIG. 2.

FIG. 5 is a flowchart of a method for receiving WLAN data incorporating receiver 20 in FIG. 2.

FIG. 6 is a flowchart of another method for receiving WLAN data incorporating receiver 20 in FIG. 2.

### DETAILED DESCRIPTION

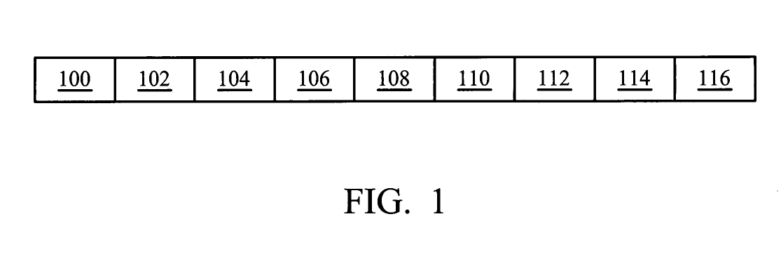

FIG. 1 shows a WLAN data frame in Media Access Control (MAC) layer in IEEE 802.11 specification, comprising frame control field 100, duration/ID field 102, address 1 field 104, address 2 field 106, address 3 field 108, sequence control field 110, address 4 field 112, frame body field 114, and frame check sequence (FCS) field 116. The WLAN data frame incorporates four address fields 104, 106, 108, 112 indicating transmitter and recipient addresses under a specific operating mode. The recipient address is located in a relatively early position in the WLAN data frame, i.e., the validity of the data frame may be verified before accepting frame body field 114. In the invention, data reception is terminated upon detection of false recipient address, providing more efficient power utilization.

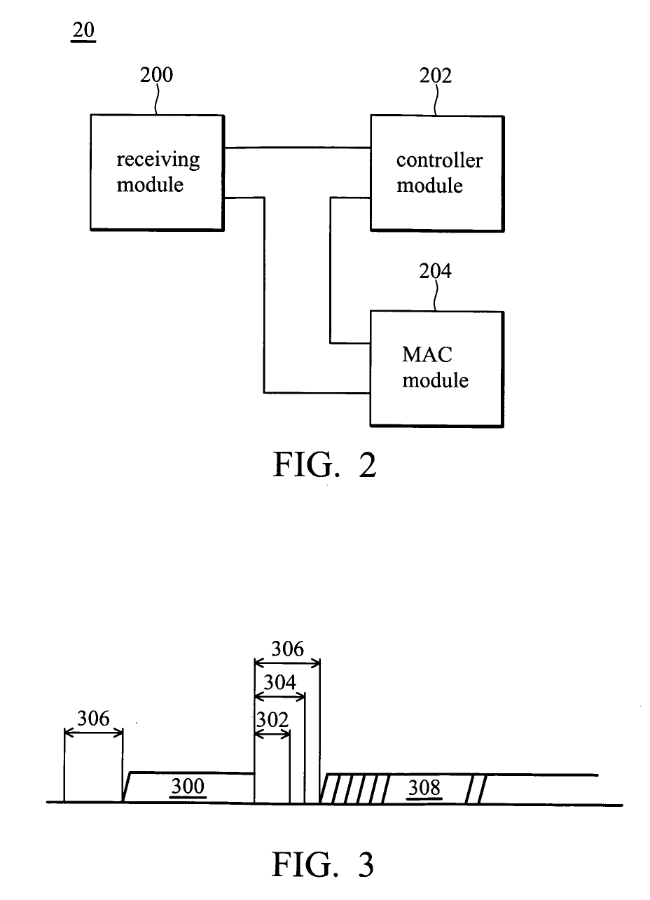

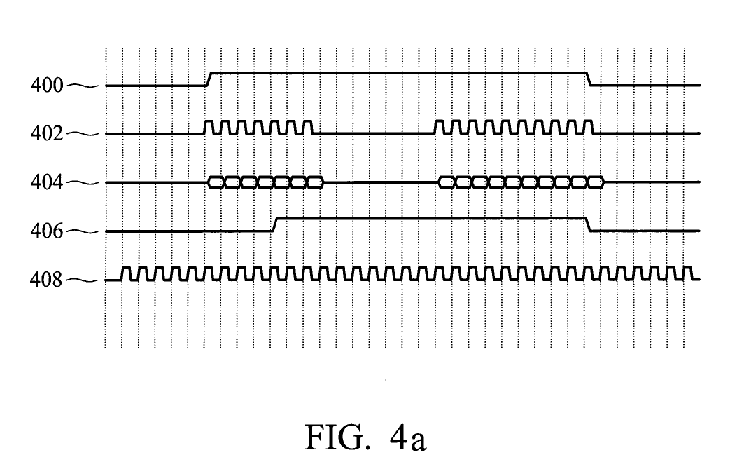

FIG. 2 is a block diagram of a receiver, according to an embodiment of the invention, in which receiver 20 comprises receiving module 200 and controller module 202. Receiving module 200 receives first data from a wired or wireless transmission medium Controller module 202 coupled to receiving module 200, accepts the first data, determines second data containing recipient information from the first data, and activates receiving module 200, based on the recipient information and the identity information of receiver 20. The recipient information may be a recipient address in the first data. The identity information may be the receiver address of receiver 20. If the recipient address corresponds to the receiver address, controller module 202 enables receiving module 200 to proceed data reception, otherwise controller module 202 disables receiving module 200 such that unnecessary data reception is prohibited and power consumption is reduced, and enables receiving module 200 after a first period has passed, the first period corresponding to IFS in FIG. 3.

FIG. 3 is a schematic diagram of IFS timing relationship in WLAN specification based on CSMA/CA, comprising busy medium 300, short IFS (SIFS) 302, PCF IFS (PIFS) 304, DCF IFS (DIFS) 306, and contention window 308. The first period is determined based on the IFS mode in operation, where the IFS mode is SIFS 302, PIFS 304, DIFS 306 or extended IFS (EIFS, not shown).

Receiver 20 may further comprise a MAC module 204 coupled to receiving module 200, accepting and executing WLAN operations based on the first data.

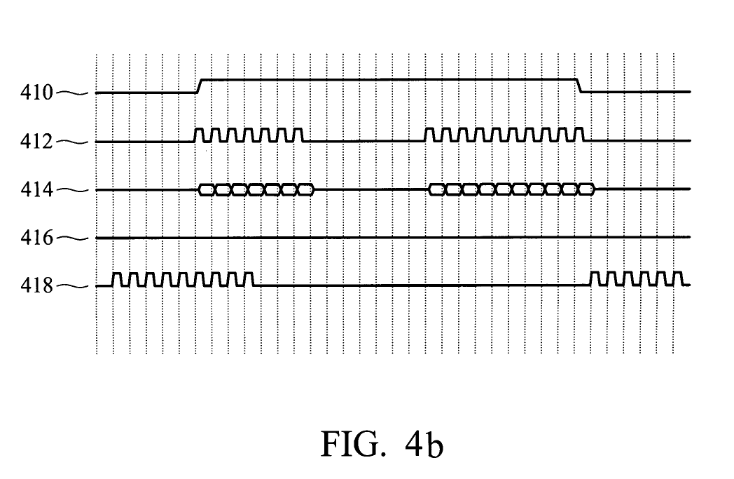

FIG. 4 (a) and (b) are timing diagrams of WLAN signals with correct recipient address and with incorrect recipient address incorporating the WLAN receiver in FIG. 2. FIG. 4(a) shows DATA_READY signal 400, DATA_VALID signal 402, DATA signal 404, MAC ADDRESS_HIT signal 406, and clock signal 408. FIG. 4(b) involves DATA_READY signal 410, DATA_VALID signal 412, DATA signal 414, MAC_ADDRESS_HIT signal 416, and clock signal 418.

As shown in FIG. 4(a), upon retrieval of a data frame, DATA_READY signal 400 switches to logic high, signifying the arrival of a data frame at controller module 302. DATA_VALID signal 402 and DATA signal 404 are fed to controller module 302 to determine the recipient address of the data frame. If the recipient address matches the receiver address, MAC_ADDRESS_HIT signal 406 is switched to logic high, indicating a correct recipient address has been retrieved, and receiver 20 completes reception of the entire data frame.

As shown in FIG. 4(b), DATA_READY signal 410, DATA_VALID signal 412, and DATA signal 414 are directed to controller module 302 for data frame retrieval. The recipient address here does not match the receiver address, such that MAC_ADDRESS_HIT signal 406 remains at logic low, receiving module 200 is disabled through the suppression of clock signal 418, and reception of the data frame is interrupted until clock signal 418 resumes.

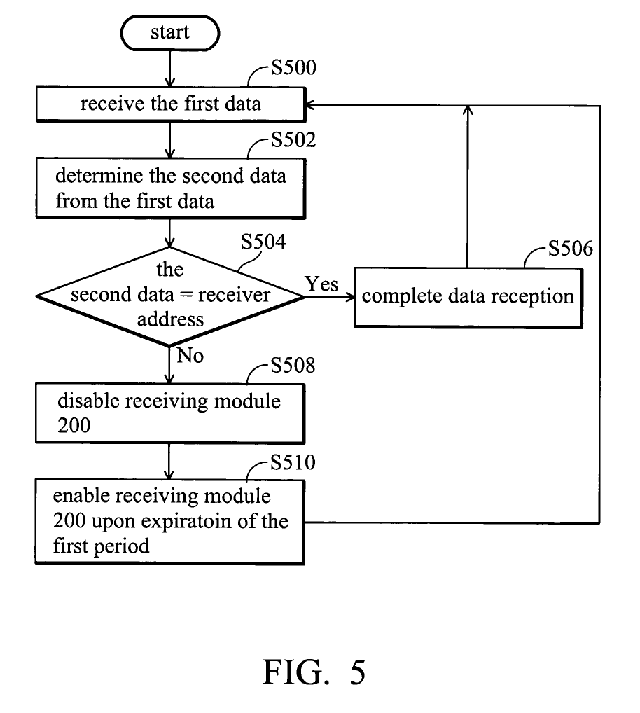

FIG. 5 is a flowchart of a method for receiving WLAN data incorporating receiver 20 in FIG. 2.

Upon receipt of WLAN data, receiving module 200 receives first data in the air and delivers the first data to controller module 202 in step s500, which in turn determines second data including recipient information from the first data in step s502.

In step s504, controller module 202 then compares the recipient information with the identity information of receiver 20. The identity information is uniquely assigned to each wireless client in the WLAN network to distinguish thereamong. The recipient information may be a recipient address for the immediate data recipient. The identity information may be an unique receiver address stored in receiver 20.

If the recipient information of the data corresponds to the identity information of receiver 20, the data is accepted and continuously retrieved for a complete data frame, as in step s506.

In step s508, if the recipient information does not match the identity information, the data is rejected and receiving module 200 is disabled by suppressing the clock signal fed thereto, or by resetting receiver 20.

In step s510, as a first period, corresponding to the completion of invalid data frame, passes, receiving module 200 is enabled once again to receive a subsequent data frame. The enablement is accomplished by issuing clock signal to receiver 20 and entering the normal data receiving procedure in step s500. Since each station in a WLAN network has to wait for a specified time interval, known as Interframe Space (IFS), prior to sending an inquiry for subsequent data transmission, the first period also correspond to Interframe Space.

In receiver 20, MAC module 204 accepts the data from receiving module 200 and responds according to WLAN specification.

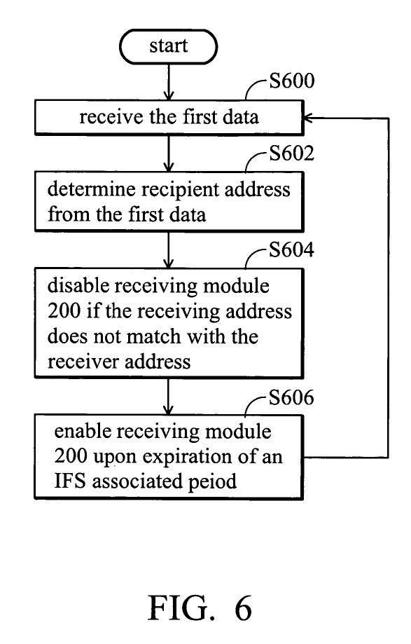

FIG. 6 is a flowchart of a method for receiving WLAN data incorporating receiver 20 in FIG. 2.

After initialization of receiver 20, in step s600 first data is received at receiving module 200, followed by step s602, where the first data is directed to controller module 202 to determine the recipient address thereof. If the recipient address does not correspond to a receiver address of receiver 20, receiving module 200 is then disabled in step s604. In step s606, receiving module 302 is enabled again upon the passing of an Interframe Space associated period. The data reception method then loops back to step s600 for retrieval of next data in receiving module 200 until the receiving process is terminated.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for receiving data in a receiver, comprising:
receiving first data in a receiving module of the receiver;
determining second data from the first data; and
disabling the receiving module, if the second data does not correspond to identity information of the receiver.

2. The method of claim 1, further comprising enabling the receiving module after a first period.

3. The method of claim 1, wherein the second data is a recipient address, and the identity information is a receiver address.

4. The method of claim 2, wherein the first period corresponds to Interframe Space.

5. The method of claim 1, wherein the disabling step comprises disabling a clock signal in the receiving module.

6. The method of claim 1, wherein the disabling step comprises resetting the receiving module.

7. A device for receiving data, comprising:
a receiving module, receiving first data;
a controller module coupled to the receiving module, determining second data from the first data, and disabling the receiving module if the second data does not correspond to identity information of the receiver.

8. The device of claim 7, wherein the controller module further enables the receiving module after a first period.

9. The device of claim 7, wherein the second data is a recipient address, and the identity information is a receiver address.

10. The device of claim 8, wherein the first period corresponds to Interframe Space.

11. The device of claim 7, wherein the controller module disabling the receiving module by disabling a clock signal in the receiving module.

12. The device of claim 7, wherein the controller module disabling the receiving module by resetting the receiving module.

13. A method for receiving data, comprising:
receiving first data in a receiving module of a receiver;
determining recipient address from the first data;
disabling the receiving module if the recipient address does not correspond to a receiver address of the receiver; and
enabling the receiving module after an Interframe Space associated period.

14. The method of claim 13, wherein the disabling and enabling steps comprise:
disabling a clock signal in the receiving module; and
enabling the clock signal in the receiving module.

15. The method of claim 13, wherein the disabling step comprises resetting the receiving module.
